(19) United States
(12) Patent Application Publication
(10) Pub. No.: US 2026/0065146 A1
(43) Pub. Date: Mar. 5, 2026

(54) BIAS MITIGATION METHOD AND SYSTEM FOR AI SYSTEMS

(71) Applicant: NEC Laboratories Europe GmbH, Heidelberg (DE)

(72) Inventors: Sascha SARALAJEW, Heidelberg (DE); Carolin LAWRENCE, Heidelberg (DE); Wiem BEN RIM, Heidelberg (DE)

(21) Appl. No.: 19/107,049

(22) PCT Filed: May 26, 2023
(86) PCT No.: PCT/EP2023/064263

§ 371 Date: Feb. 27, 2025

(30) Foreign Application Priority Data
Oct. 28, 2022 (EP) 22204462

(51) Int. Cl. G06N 20/00

(52) U.S. Cl. CPC G06N 20/00

(57) ABSTRACT

A computer-implemented method for supporting bias mitigation in an artificial intelligence (AI) system includes determining a set of sensitive attributes and providing a dataset including a number of data elements. Each data element is labelled with sensitive attributes. The AI system runs on the dataset and determines whether a prediction for an element is correct. Upon checking whether a bias with regard to a sensitive attribute is present, for each sensitive attribute that exhibits a bias, a model is trained for an attribute-based global explanation for each class of correct and incorrect predictions. For each incorrectly predicted data element based on the trained model for the at least one attribute-based global explanation, a counterfactual data element is generated that leads to a correct classification. The method has applications including, but not limited to, use cases in facial recognition and medical/healthcare for optimizing machine learning and supporting decision making.

### CROSS REFERENCE TO RELATED APPLICATIONS

This application is a U.S. National Phase application under 35 U.S.C. § 371 of International Application No. PCT/EP2023/064263, filed on May 26, 2023, and claims benefit to European Patent Application No. 22204462.0, filed on Oct. 28, 2022. The International Application was published in English on May 2, 2024 as WO 2024/088602 A1 under PCT Article 21(2).

### FIELD

The present invention relates to a computer-implemented method for supporting bias mitigation in an existing AI system as well as to a computer system programmed for supporting bias mitigation in an existing AI system.

### BACKGROUND

Existing AI systems might be biased, for example; a facial image detection or recognition system might recognize people with darker skin colour less reliably than people with lighter skin colour.

While it is possible to measure the existence of bias in an AI system (for reference, see, e.g., O. Aka, K. Burke, A. Bäuerle, Ch. Greer, and M. Mitchell: “Measuring Model Biases in the Absence of Ground Truth”, in Proceedings of the 2021 AAAI ACM Conference on AI, Ethics, and Society (2021), no method exists that can automatically reduce the bias of such as system. It is difficult and time consuming for the AI developer to modify a system so that it has less bias because AI systems are a black box and it is not clear on which features a system picked up that led to bias. For example, a system might have learnt that people with short hair should be classified as male. This would then mean females with short hair are misclassified. As the AI is a black box, an AI developer cannot identify such issues without painstakingly searching for such behaviour using explainable AI methods. It would therefore save the developer a lot of time, if a method existed that can automatically detect existing bias and update a system to reduce this bias.

Additionally, it is often not understandable why an AI makes a certain prediction or how to change the input minimally to receive a different prediction.

FairML (for reference, see https://github.com/adebayoj/fairml) is a Python open-source toolbox for researchers to check their predictive models for bias. Google's What-if open-source tool (for reference, see J. Wexler, M. Pushkarna, T. Bolukbasi, M. Wattenberg, F. Viegas, and J. Wilson: “The What-If Tool: Interactive Probing of Machine Learning Models”, in. IEEE Transactions on Visualization and Computer Graphics, vol. 26, Issue: 1, January 2020, pp. 56-65, 10.1109/TVCG.2019.2934619) also allows for the same analysis. When using these auditing toolboxes, researchers can change a specific input and check the effect on the performance of the model. While this is useful to detect bias in models, it proves to be disadvantageous in that it requires users to know which inputs to perturb in order to detect bias.

Another tool is AI Fairness 360 (for reference, see R. K. E. Bellamy et al.: “AI Fairness 360: An extensible toolkit for detecting and mitigating algorithmic bias” in IBM Journal of Research and Development, vol. 63, no. 4/5, pp. 4:1-4:15, 1 Jul.-Sep. 2019, doi: 10.1147/JRD.2019.2942287), which encompasses 70 fairness metrics that help detect bias in models, and 10 algorithms to eliminate it. The drawback of using this method is the need to provide access to training, testing and validating data, which can be proprietary and put the user information at risk.

### SUMMARY

In an embodiment, the present disclosure provides a computer-implemented method for supporting bias mitigation in an existing AI system. The method includes determining a set of one or more sensitive attributes and providing a dataset including a number of data elements, where each of the data elements is labelled with attributes of the determined set of one or more sensitive attributes. The existing AI system is run on the dataset and determining for each data element of the dataset whether a prediction of the existing AI system is correct or not. Whether a bias with regard to a sensitive attribute is present is checked, and for each sensitive attribute that exhibits a bias, a model is trained for at least one attribute-based global explanation for each class of correct predictions and incorrect predictions. For each incorrectly predicted data element of the dataset based on the trained model for the at least one attribute-based global explanation, a counterfactual data element is generated that leads to a correct classification by the existing AI system. The method has applications including, but not limited to, use cases in facial recognition and medical/healthcare for optimizing machine learning and supporting decision making.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view showing an overview of the architecture of an automated bias mitigator in accordance with an embodiment of the present invention;

FIG. 2 is a flow chart showing input preparation for operation of an automated bias mitigator in accordance with an embodiment of the present invention;

FIG. 3 is a flow chart showing operation of an attribute-based global explanation generator of an automated bias mitigator in accordance with an embodiment of the present invention;

FIG. 4 is a flow chart showing operation of a counterfactual generator of an automated bias mitigator in accordance with an embodiment of the present invention; and

FIG. 5 is a flow chart showing operation of a system updater of an automated bias mitigator in accordance with an embodiment of the present invention.

### DETAILED DESCRIPTION

Embodiments of the present disclosure provide an improved concept for supporting bias mitigation in an existing AI system that can be used to detect and remove unwanted biases before deployment of the AI system. In accordance with the present disclosure, this can be accomplished in an embodiment by a computer-implemented method for supporting bias mitigation in an existing AI system, the method comprising: determining a set of one or more sensitive attributes and providing a dataset including a number of data elements, where each of the data elements is labelled with the attributes of the determined set of one or more sensitive attributes; running the existing AI system on said dataset and determining for each data element of said dataset whether the prediction of the existing AI system is correct or not; checking whether a bias with regard to a sensitive attribute is present and training, for each sensitive attribute that exhibits a bias, a model for at least one attribute-based global explanation for each of the classes of correct predictions and incorrect predictions; and generating, for each incorrectly predicted data element of the dataset based on the learned model for the at least one attribute-based global explanation, a counterfactual data element that leads to a correct classification by the existing AI system.

Furthermore, embodiments of the present disclosure provide the improved concept for supporting bias mitigation in an existing AI system that can be used to detect and remove unwanted biases before deployment of the AI system by a computer system and by a tangible, non-transitory computer-readable medium.

With the concepts for bias mitigation support proposed herein, bias in its different forms can be detected and reduced automatically, in particular without a user of the system being required to know which inputs to perturb in order to detect bias. Furthermore, the concepts proposed herein do not require access to training, testing and validating data of the existing AI system, which can be proprietary and put the user information at risk. In contrast, embodiments of the proposed concept bypass the need of inspecting the data by testing the model itself and updating it to return an improved model. In addition, the approach proposed herein does not require access to the model itself and, thus, proprietary (black box) models can be analysed by only inspecting their classification behaviour. Embodiments of the proposed concept can be used to detect and remove unwanted biases before deployment and to obtain an explanation of why a bias exists, which can also serve as recommendations on what would need to change in the input to reach a different prediction.

Compared to existing approaches, embodiments of the approach disclosed herein leverage the advantages of interpretable prototype-based models to provide local and global explanations. Because these models are fully transparent, their explanations are faithful. Thus, they can uncover the decision process of black boxes up to an arbitrary granularity and can give precise information about how to correct the data.

Embodiments of the proposed concept assume that the existing AI system to be tested operates in a dimensionality that is high enough so that it is possible to separate the data and classify with high accuracy while not using any sensitive attributes to achieve this.

An aspect of the proposed concept relates to the creation of global explanations based on sensitivity attributes and whether an original AI model predicted correctly or incorrectly for a set of inputs.

A further aspect of the proposed concept relates to the creation of a counterfactual input for each incorrectly classified input by moving the original data element (e.g., an image) minimally closer to the global explanation that is based on the distribution of correctly predicted inputs.

A further aspect relates to the creation of a set of alternative inputs, which can be used to update the original model to reduce its bias, by generating a series of inputs by gradually modifying a counterfactual shift parameter t (that defines a measure of how much the input is moved closer to the global explanation/prototype), and by using the generated counterfactual data elements together with the original data elements to gradually update the original AI model.

According to an embodiment, it may be provided that the checking whether a bias with regard to a sensitive attribute is present, is performed by determining if the predictions of the existing AI system on the data elements with the respective sensitive attribute are disproportionally more often wrong. This determination may be made by computing the corresponding conditional probability or by using diversity and inclusion metrics.

According to an embodiment, it may be provided that prototype-based learning is used for training the model for at least one attribute-based global explanation for each of the classes of correct predictions and incorrect predictions. Prototype-based learning provides the advantage of interpretability and, as the respective explanations are faithful, of full transparency.

According to an embodiment, a local explanation may be created for each incorrectly predicted data element of the dataset and/or for each generated counterfactual data element. This may be realized by computing a classification correlation matrix.

According to an embodiment, it may be provided that the method includes a step of creating, for each data element of the dataset and for each generated counterfactual data element, a series of inputs that gradually transition from original to counterfactual. This may be realized by binning correlation values and replacing features of the original data element of the dataset with features of the counterfactual data element.

According to an embodiment, it may be provided that the generated counterfactual data elements together with the original data elements of the dataset are used as training data to update the existing AI system, for instance by means of curriculum learning techniques.

According to an embodiment, it may be provided that, during the updating of the existing AI system, continual learning techniques are used to keep track of (and not forget) previously correct predictions of the existing AI system. According to an embodiment, the updating of the existing AI system may be terminated once the original data elements of the dataset are predicated correctly.

According to an embodiment, it may be provided that the update of the existing AI system is provided as an updated system for making predictions with less bias with regard to the determined sensitive attributes.

Embodiments of the present disclosure provide methods and apparatus for detecting and removing unwanted biases in an existing AI system. Detection and removal of such unwanted biases can be performed before deployment of the respective AI system, for example, by (1) highlighting their existence, (2) identifying why the bias exists, and/or (3) updating the model to reduce the bias. The explanation of why a bias exists, can also serve as recommendations on what would need to be changed in the input to the AI system to reach a different prediction. For instance, this can aid to explain how a person who, e.g., will likely develop a disease could become more similar to a person who will likely stay healthy.

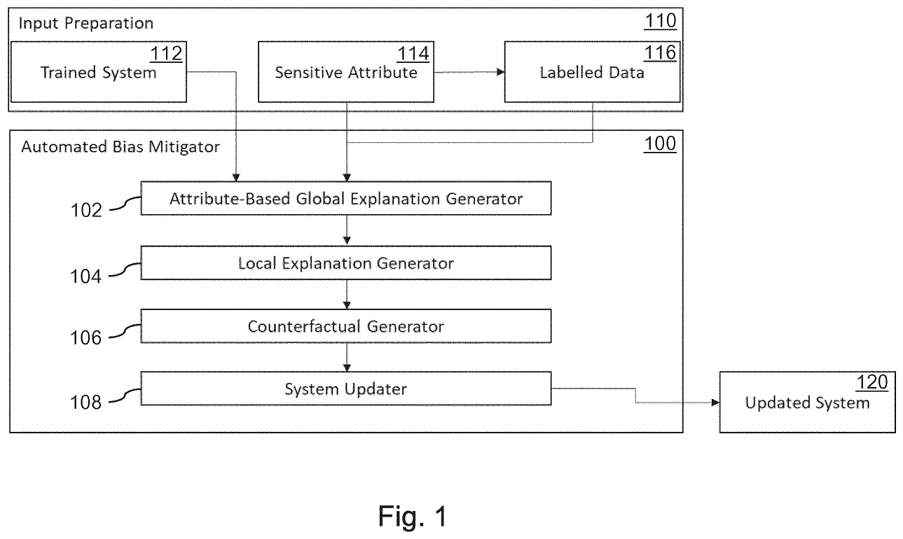

FIG. 1 provides an overview of an architecture for an automated bias mitigator 100 according to an embodiment of the present invention.

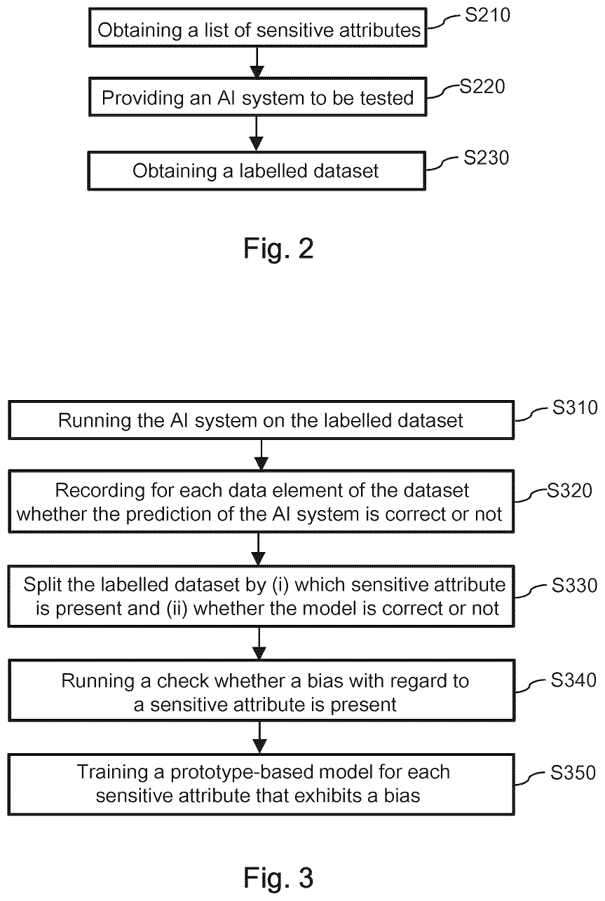

As shown in the embodiment of FIG. 1, the bias mitigation method starts with an input preparation 110. The input preparation 110, of which an exemplary flow chart is shown in FIG. 2, includes the definition or determination of at least one sensitive attribute 114, as shown at step S210 in FIG. 2. It should be noted that the present disclosure is not limited in any way with respect to the selection of one or more sensitive attributes 114, i.e. the sensitive attributes 114 may relate to any desired aspect. For instance, a sensitive attribute 114 may be, e.g., gender, race, or health status, to name just a few common examples.

Furthermore, as shown at step S230 in FIG. 2, input preparation 110 includes the preparation or provision of a labelled dataset 116, where each data element or data point of the dataset 116 is labelled with the one or more sensitive attributes 114. The sensitive attribute(s) 114 can either be manually labelled or potentially automatically generated by an additional AI system. Advantageously, the dataset 116 should have sufficient coverage of each sensitive attribute 114. It should be noted that the present disclosure is not limited in any way with respect to the specific type of the data points/elements of dataset 116. According to an embodiment, the data points/elements may be images.

The input preparation 110 further includes the provision of a trained AI system 112 that is to be analysed in terms of prevalent bias, as shown at step S220 of FIG. 2. It should be noted that the present disclosure is not limited in any way with respect to the specific type of trained system, i.e. the trained system 112 may be any system that performs a classification on a problem of interest. For instance, the trained system 112 may be a facial detection and recognition system. In any case, the trained system 112 is the output of a development and training process. As such, it is envisioned that the method according to embodiments disclosed herein should be applied before the trained system 112 is deployed to ensure that only fair systems (i.e. without any bias or at least with as little bias as possible) are deployed.

As shown in FIG. 1, bias mitigator 100 comprises an attribute-based global explanation generator 102. The operation of this component may be as follows:

After performing input preparation 110 as explained above, each data point of the labelled dataset 116 may be passed to the trained system 112. The respective predictions of the trained system 112 as well as the labelled data are passed to the attribute-based global explanation generator 102 as input. The attribute-based global explanation generator 102 is configured to record for every data point whether the trained system 112 predicted it correctly or not (by comparing the prediction of the trained system 112 with the label of the respective data point).

Additionally, the attribute-based global explanation generator 102 may be configured to take note which value of the sensitive attribute(s) 114 each data point has. Based on this information, each data point may be categorized into one of the below categories of Table 1:

TABLE 1

| | |
|---|---|
| Prediction correct | Prediction not correct |

Sensitive attribute 1
Sensitive attribute . . .
Sensitive attribute n

Accordingly, the dataset 116 may be split into a series of sensitive attributes 114 and whether the trained AI system 112 predicts a data point correctly or not.

According to an embodiment, the attribute-based global explanation generator 102 may be further configured to check, for each sensitive attribute 114, whether there is a bias present by comparing if the predictions of the trained system 112 on the data points with the respective sensitive attribute 114 are disproportionally more often wrong. This can, for example, be done by computing the corresponding conditional probability or by using diversity and inclusion metrics (as described in Mitchell et al.: “Diversity and Inclusion Metrics in Subset Selection”, AIES '20, Feb. 7-8, 2020, New York, NY, US, https://dl.acm.org/doi/pdf/10.1145/3375627.3375832, which is hereby incorporated by reference herein) and, where appropriate, by applying predefined thresholds.

If it is determined that bias exists for at least one sensitive attribute 114, the method may proceed with the next steps as described below for each sensitive attribute 114 that exhibits bias.

According to an embodiment, it may be provided that the attribute-based global explanation generator 102, based on the entries of Table 1, uses prototype-based learning to generate a global explanation for each sensitive attribute 114, which outputs at least one prototype for each correct and incorrect prediction set across the given dataset 116. It is important to note that this task cannot be performed by a local post-hoc explainer like LIME (Local Interpretable Model-agnostic Explanations), because such explainer would generate a new model for each individual data point. Rather, the bias mitigation support proposed in the present disclosure aims at generating a global explanation for each sensitive attribute 114 and correct/incorrect prediction. An example algorithm for performing this task could be the Generalized Learning Vector Quantization (GLVQ) algorithm, as described in A. Sato and Y. Keiji: “Generalized learning vector quantization”, in Advances in neural information processing systems 8 (1995), or the extended GML VQ algorithm (Generalized Matrix Learning Vector Quantization), as described in P. Schneider, M. Biehl and B. Hammer: “Adaptive relevance matrices in Learning Vector Quantization”, in Neural Computation, vol. 21, no. 12, pp. 3532-3561, 2009, which both are hereby incorporated by reference herein.

In the case of GMLVQ, the attribute-based global explanation generator 102 may do the following:

The classifier may have a set of prototypes, which are trainable vectors in the input space. For example, the prototypes can be images of faces (cropped from the original images by using the ground-truth labels of the dataset 116), with one prototype per class. So, given the category, the model learns one prototype (i.e., a face) of missed faces and one prototype of found faces and an importance matrix. After training GMLVQ, these prototypes resemble the common differences between the classes and the matrix highlights the important features in the inputs. Given a sample x (a face) and a prototype w, GMLVQ computes the distance between x and w by:

$$d ( x , w ) = {( x - W )}^{T} \cdot {Ω}^{T} \cdot Ω \cdot ( x - w ) ,$$

which is a Mahlanobis like distance (with the matrix Ω having full rank in the present case). During training the model, the matrix Ω and the two prototypes wₘ (missed) and w_{f} (found) are optimized such that input samples are classified correctly. In summary, GML VQ returns global explanations by the prototypes and the learned matrix.

With reference to FIG. 3, the operation of the attribute-based global explanation generator 102 according to an embodiment of the present disclosure can be summarized as follows:

For each sensitive attribute 114, the attribute-based global explanation generator 102 may run the AI system 112 on the dataset 116, as shown at step S310 of FIG. 3, and record for each data element of the dataset 116 whether the model prediction of the AI system 112 is correct or not, as shown at step S320. Next, for each sensitive attribute 114, the dataset 116 may be split by (i) which sensitive attribute is present (ii) and whether the model is correct or not, as shown at step S330. After this system output preparation, the attribute-based global explanation generator 102 may run a check whether a bias with regard to a sensitive attribute 114 is present, as shown at S340. If bias of at least one sensitive attribute 114 is present, the method proceeds by training, for each sensitive attribute 114 that exhibits a bias, a prototype-based model by using original inputs and whether or not the original model predicted it correctly as training data to create at least one global explanation for each class of ‘predicted correctly’ vs ‘predicted incorrectly’ (S350).

According to an embodiment, it may be provided that, based on the global explanation prototypes, e.g., generated as described above, a local explanation is created for each input. This task may be performed by local explanation generator 104, as shown in FIG. 1.

For creating local explanations, the local explanation generator 104 may be configured to compute a classification correlation matrix. This matrix highlights the correlation between intensity values when measuring the distance. For example, in the case of image data, if differences between the intensity values at a certain pixel position are important (high value), this means that this pixel emphasizes class differences. Usually, the most important differences are at the main diagonal of the correlation matrix, which means given a pixel position (i,j) differences in the intensity values at this position are important for class discrimination.

The distance computation can be decomposed into the individual contributions for each pixel position:

$${d ( x , w ) \vert}_{i , j} = ( {x}_{i , j} - {w}_{i , j} ) {\sum }_{k , l} {λ}_{( i , j ) , ( k , l )} ( {x}_{k , l} - {w}_{k , l} ) .$$

According to an embodiment, when visualizing the correlation values λ_{(i,j),(k,l)}, the contributions may be visualized averaged over the RGB channels, to reduce the number of visualizations. Then, the main diagonal of the correlation matrix, i.e., λ_{(i,j),(k,l)}, can be shown to highlight the image regions that are most important for class discrimination.

As will be appreciated by those skilled in the art, the approach described above for the case of the data being images can likewise be applied for other kind of data, e.g. tabular data.

According to an embodiment, the method may then proceed to the counterfactual generator 106 of the bias mitigator 100, which is configured to create counterfactual inputs. A counterfactual is a modification of an original input that flips model decisions. Typically, counterfactuals are the most valuable when they only minimally differ from the original.

Using the learned model for the global explanation, the counterfactual generator 106 may iterate over each incorrectly classified input and compute a counterfactual. The created counterfactual will cause the original model to now output the correct decision. This is done by moving the original input closer to the prototype that represents the distribution of the correctly classified inputs. How much the input is moved closer to the prototype can be controlled via a counterfactual shift parameter t.

In addition to computing the counterfactuals, the counterfactual generator 106 may be configured to output an updated version of the misclassified samples. By providing/showing a user of the system an updated version of the misclassified samples, the user is assisted in answering the question of “What do I have to change in my input so that the misclassification is corrected?” By this step, the present disclosure presents an approach that goes beyond the commonly used format for explanations (e.g., what are important features in the input with respect to the classification decisions) since the explanations generated by the counterfactual generator 106 show for each sample what can be changed to be a correct sample.

It should be noted that the counterfactual generator 106 can also be configured to be used alongside the final system in order to explain how an input would have to be changed to receive a different prediction. This is for example helpful to understand how a patient needs to change in order to more likely be a healthy instead of a diseased person.

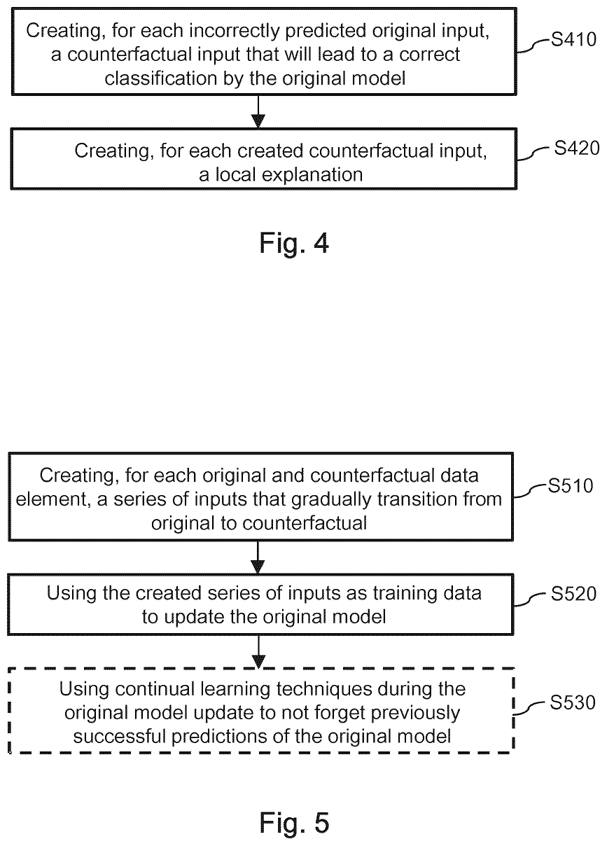

With reference to FIG. 4, the operation of the counterfactual generator 106 according to an embodiment of the present disclosure can be summarized as follows:

As shown at step S410 of FIG. 4, the counterfactual generator 106 may create, for each incorrectly predicted original input, a counterfactual input that will lead to a correct classification by the original model 112. Furthermore, as shown at step S420, for each counterfactual from step S410, the counterfactual generator 106 may create a local explanation as described above.

Additionally, the counterfactual generator 106 may serve as an explanation of the final system 120. For example, it can explain how a person who will likely develop a disease could become more similar to a person who will likely stay healthy.

According to an embodiment, the method may then proceed to the system updater 108 of the bias mitigator 100. The system updater 108 may be configured to create, based on the counterfactual shift parameter t as determined by and received from counterfactual generator 106, a series of counterfactuals from the original image. (It is again noted that images are only mentioned by way of example and that method can be executed likewise for other kind of data). At least one counterfactual in the series will lead to a correct classification by the original model 112. The most extreme case for this would be recovering the prototype for the correct class itself.

The series of images based on each misclassified input may then be used as training data to update the original model 112. For example, this can be done in a curriculum learning type of update for the original system 112. The process may start with the counterfactual most similar to the prototype for correct classifications and may then move towards showing the original model the original input. Through this gradually change (i.e. by means of a series of gradually shifting counterfactual inputs), the model will learn how to also correctly classify the original image-therefore reducing the bias of the original model 112 in its updated version. Training may stop once the original image is also classified correctly. During training, one can also observe the performance on the original test set, in order to ensure that it does not drop outside acceptable margins. One can then either perform early stopping to find the best trade-off between performance and fairness metrics. Additional techniques to ensure that the remaining original inputs are not forgotten can be utilized, e.g., continual learning techniques such as Bilevel Continual Learning, as described in A. Shaker et al: “Bilevel Continual Learning”, 2021, https://arxiv.org/abs/2011.01168, which is hereby incorporated by reference herein.

The output of the system updater 108 is an updated system 120, which exhibits less bias with regard to the defined sensitive attributes 114 that previously caused a bias in the original system 112.

With reference to FIG. 5, the operation of the system updater 108 according to an embodiment of the present disclosure can be summarized as follows:

As shown at step S510, for each original and counterfactual data element created by the counterfactual generator 106, the system updater 108 creates a series of inputs that gradually transition from original to counterfactual. This may be performed by binning correlation values and replacing features of the original data element with features of the counterfactual element. Furthermore, the system updater 108 may use the data created in step S510 as training data to update the original model 112 until the bias is reduced and the potentially performance drop is within an acceptable margin. As an optional step, shown at S520, the system updater 108 may employ continual learning techniques during step S510 to not forget previously successful predictions of the original model 112.

According to an embodiment, a computer-implemented method is provided for supporting bias mitigation in a facial image detection and/or recognition system. With reference to FIG. 1, the facial image detection and/or recognition system may constitute the trained system 112 (which is to be assessed with regard to bias) and may be trained such that faces are automatically recognized and classified. This can have various use cases, such as (1) airport security gates, (2) smart cities, (3) hospital support, (4) ticket free theme-park entrance systems, (5) ATM systems with biometrics, to name just a few. In all embodiments, if a person is recognized and deemed to have access, a security barrier is automatically opened.

In this embodiment, the labelled dataset 116 may be a facial image dataset, i.e. including facial images as data elements, wherein the facial images are labelled with (predefined or selectable) sensitive attributes (e.g. gender, race). In this scenario, the proposed method according to aspects and embodiments described herein may check whether people are discriminated against if they, for example, have darker skin colour or are female. If this is the case, the proposed method according to aspects and embodiments described herein may be run to generate additional training data with which the system can be updated. As a result, the method provides an updated facial image detection and/or recognition system (constituting the updated system 120 shown in FIG. 1) with less bias present. As already mentioned above, like in the original system 112, the updated system 120 may be used to recognize faces and to automatically open a security barrier or gate if a recognized person is not deemed dangerous and/or is deemed to have access. However, compared to the original system 112, the updated system 120 generated in accordance with the concepts of the present disclosure operates with less bias and a higher degree of fairness.

According to another embodiment, a computer-implemented method is provided for supporting bias mitigation in a patient illness prediction and/or treatment recommendation system. With reference to FIG. 1, the patient illness prediction and/or treatment recommendation system may constitute the trained system 112 (which is to be assessed with regard to bias) and may be trained such that the system automatically identifies illnesses of a patient (e.g. COVID) and possibly informs a physician and/or that the system recommends a treatment for an identified illness, e.g. a (personalized) drug. In this embodiment, the labelled dataset 116 may include tabular data about the patient or a medical image of the patient (e.g., x-ray or the like) or time series data.

In this scenario, the proposed method according to aspects and embodiments described herein may check whether people are discriminated against, for example by gender. If this is the case, the proposed method according to aspects and embodiments described herein may be run to generate additional training data with which the system can be updated. According to an embodiment, it may be provided that the counterfactual generator 106 checks whether a person is more similar to an ill patient. If yes, it may compute a counterfactual how the person can become more similar to a healthy patient.

As a result, the method provides an updated patient illness prediction and/or treatment recommendation system (constituting the updated system 120 shown in FIG. 1) that recognizes diseases and/or predicts treatments with less bias present, thereby ensuring that illness and treatment recognition work equally well across the population. Furthermore, the method may provide an output that explains to a person (e.g., a doctor and/or a patient) how a person who will likely develop a certain disease could become more similar to a person who will likely stay healthy, i.e. what needs to change to become more similar to a healthy person.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for supporting bias mitigation in an existing artificial intelligence (AI) system, the method comprising:
determining a set of one or more sensitive attributes and providing a dataset including a number of data elements, where each of the data elements is labelled with the attributes of the determined set of one or more sensitive attributes;
running the existing AI system on the dataset and determining for each data element of the dataset whether a prediction of the existing AI system is correct or not;
checking whether a bias with regard to a sensitive attribute is present and training, for each sensitive attribute that exhibits a bias, a model for at least one attribute-based global explanation for each class of correct predictions and incorrect predictions; and
generating, for each incorrectly predicted data element of the dataset based on the trained model for the at least one attribute-based global explanation, a counterfactual data element that leads to a correct classification by the existing AI system.

2. The method according to claim 1, wherein checking whether the bias with regard to the sensitive attribute is present includes:
determining, by computing a corresponding conditional probability or by using diversity and inclusion metrics, whether the predictions of the existing AI system on the data elements with a respective sensitive attribute are disproportionally more often wrong.

3. The method according to claim 1, wherein prototype-based learning is used for training the model for at least one attribute-based global explanation for each of the classes of correct predictions and incorrect predictions.

4. The method according to claim 1, further comprising:
creating, for each incorrectly predicted data element of the dataset and/or for each generated counterfactual data element, a local explanation by computing a classification correlation matrix.

5. The method according to claim 1, further comprising:
creating, for each data element of the dataset and for each generated counterfactual data element, a series of inputs that gradually transition from original to counterfactual by binning correlation values and replacing features of the original data element of the dataset with features of the counterfactual data element.

6. The method according to claim 5, further comprising:
using the generated counterfactual data elements together with the original data elements of the dataset as training data to update the existing AI system.

7. The method according to claim 6, further comprising:
using, during the updating of the existing AI system, continual learning techniques to keep track of previously correct predictions of the existing AI system.

8. The method according to claim 6, wherein the update of the existing AI system is terminated once the original data elements of the dataset are predicated correctly.

9. The method according to claim 6, further comprising:
providing the update of the existing AI system as an updated system for making predictions with less bias with regard to the determined sensitive attributes.

10. A computer system programmed for supporting bias mitigation in an existing artificial intelligence (AI) system, the computer system comprising one or more processors which, alone or in combination, are configured to provide for execution of the following steps:
running the existing AI system on a dataset including a number of data elements, where each of the data elements is labelled with attributes of a determined set of one or more sensitive attributes, and determining for each data element of the dataset whether a prediction of the existing AI system is correct or not;
checking whether a bias with regard to a sensitive attribute is present and learning, for each sensitive attribute that exhibits a bias, a model for at least one attribute-based global explanation for each class of correct predictions and incorrect predictions; and
generating, for each incorrectly predicted data element of the dataset based on the trained model for the at least one attribute-based global explanation, a counterfactual data element that leads to a correct classification by the existing AI system.

11. The system according to claim 10, further comprising an attribute-based global explanation generator configured to:
determine, by computing a corresponding conditional probability or by using diversity and inclusion metrics, whether the predictions of the existing AI system on the data elements with a respective sensitive attribute are disproportionally more often wrong; and
use prototype-based learning for training the model for at least one attribute-based global explanation for each of the classes of correct predictions and incorrect predictions.

12. The system according to claim 10, further comprising a local explanation generator configured to create, for each incorrectly predicted data element of the dataset and/or for each generated counterfactual data element, a local explanation by computing a classification correlation matrix.

13. The system according to claim 10, further comprising a counterfactual generator configured to:
compute, for each data element of the dataset incorrectly classified by the existing AI system and using the trained model for at least one attribute-based global explanation, a counterfactual data element that causes the existing AI system to output a correct prediction.

14. The system according to claim 10, further comprising a system updater configured to
create, for each data element of the dataset incorrectly classified by the existing AI system, a series of counterfactual data elements; and
use the series of counterfactual data elements as training data to update the existing AI system.

15. A tangible, non-transitory computer-readable medium supporting bias mitigation in an existing artificial intelligence (AI) system having instructions thereon, which, upon being executed by one or more processors, provide for execution of the following steps:
running the existing AI system on a dataset including a number of data elements, where each of the data elements is labelled with attributes of a determined set of one or more sensitive attributes, and determining for each data element of the dataset whether a prediction of the existing AI system is correct or not;
checking whether a bias with regard to a sensitive attribute is present and learning, for each sensitive attribute that exhibits a bias, a model for at least one attribute-based global explanation for each class of correct predictions and incorrect predictions; and
generating, for each incorrectly predicted data element of the dataset based on the learned model for the at least one attribute-based global explanation, a counterfactual data element that leads to a correct classification by the existing AI system.
